(19) United States
(12) Patent Application Publication
(10) Pub. No.: US 2019/0138668 A1
(43) Pub. Date: May 9, 2019

(54) SYSTEM AND METHOD FOR SIMULATING MACHINING EFFECTS

(71) Applicant: HONEYWELL FEDERAL MANUFACTURING & TECHNOLOGIES, LLC, Kansas City, MO (US)

(72) Inventors: ERIC SAWYER, Kansas City, MO (US); Jordan Herrema, Kansas City, MO (US); Wesley Everhart, Kansas City, MO (US)

(73) Assignee: HONEYWELL FEDERAL MANUFACTURING & TECHNOLOGIES, LLC, Kansas City, MO (US)

(21) Appl. No.: 15/806,376

(22) Filed: Nov. 8, 2017

(51) Int. Cl. G06F 17/50

(52) U.S. Cl. CPC G06F 17/5009; G05B 13/04

(57) ABSTRACT

A system and method for improving the simulation of machining effects in an object on computer-aided design models by imparting micro level machining stress and strain effects on a macro part model in a time-realistic manner. A reference machining operation is performed on a micro reference model. A transfer map based on a pre-machining stress-strain gradient and a post-machining stress-strain gradient is created. A machining operation is then performed on the macro part model with the pre-machining stress-strain gradient and the post-machining stress-strain gradient being mapped to the macro part model. The macro level machining operation and mapping are performed in a time-realistic manner.

### BACKGROUND

Finite element analysis (FEA) is often performed on computer-aided design (CAD) models for evaluating stress and strain characteristics of parts, products, and other objects. The stress and strain characteristics of an object are primarily functions of the object's shape, which is often affected by machining and other material removal and material additive operations. Unfortunately, conventional machining simulations must make a very steep tradeoff between the accuracy of machining-induced stresses and strains versus the part size and simulation duration that can be captured. In recent FEA advancements, machining-induced stress and strain effects in micro level machining simulations have been mapped onto macro level part models. However, this approach considers machining-induced stress and strain on the macro level only in a timeless manner, which results in significant inaccuracies in the overall stress and strain analysis.

### SUMMARY

Embodiments of the present invention solve the above-described problems and provide a distinct advance in the art of finite element analysis. More particularly, embodiments of the invention provide a system and computer-implemented method for improving the simulation of machining effects on CAD models.

An embodiment of the invention is a computer-implemented method for improving the simulation of machining effects on computer-aided design models by imparting micro level machining stress and strain effects on a macro level part model in a time-realistic manner. First, a micro reference model including a number of micro reference model elements having a pre-machining stress-strain gradient may be created. The pre-machining stress-strain gradient may represent forging, extrusion, or casting stresses and strains, for example.

A reference machining operation may then be performed on the micro reference model such that machining stress and strain are imparted on the micro reference model. Micro reference model elements surviving the reference machining operation will thus have a post-machining stress-strain gradient. The reference machining operation may comprise machining simulation modeling including the use of a reference machining tool and realistic physics to the level of complexity desired. For example, the reference machining operation may simulate the tool ploughing through material to obtain stresses, strains, reaction forces, and other data.

A transfer map based on the pre-machining stress-strain gradient and the post-machining stress-strain gradient may then be created. In its simplest form, the transfer map forms one-to-one relationships between data points of the pre-machining stress-strain gradient and data points of the post-machining stress-strain gradient. In more complex forms, relationships between data points of the pre-machining stress-strain gradient and data points of the post-machining stress-strain gradient may be conditional or modified based on predetermined criteria.

A macro part model including a number of macro part model elements having a pre-machining stress-strain gradient may then be created. For example, extrusion or casting stresses may be induced on the macro part model.

A machining operation may then be performed on the macro part model. More specifically, one or more macro part model elements may be selected for removal from the macro part model to simulate physical removal of material. This will result in a number of unremoved macro part model elements remaining. Macro part model elements being removed may be selected based on coordinate space locations of the macro part model elements, element connectivity of the macro part model elements, or any other suitable paradigm. In most embodiments, macro part model elements or groups of macro part model elements may be removed in succession along a tool path so as to simulate physical removal of material via a machining tool. In some embodiments, the macro level machining operation uses a point load force following a tool path on the macro part model geometry. At this point, the unremoved macro part model elements have a stress-strain state that will be used as a basis for micro reference model transfer mapping as described below.

The post-machining stress-strain gradient of the micro reference model may then be mapped to the unremoved macro part model elements according to the transfer map such that the unremoved macro part model elements have a post-machining stress-strain gradient based on the pre-machining stress-strain gradient and the post-machining stress-strain gradient of the micro reference model and the stress-strain state of the unremoved macro part model elements.

The mapping may be based on “before” and “after” values of equivalent plastic strain (EQPS), Cauchy stress, or any other suitable material property. For more complex material models such as the Bammann-Chiesa-Johnson Microstructural Evolution Model (BCJ-MEM) model, recrystallization, estimated room temperature yield stress, and other material properties may be used. Many material models have hundreds of variables, any of which could potentially be used in this regard. Multiple variables could even be used in conjunction with each other.

Macro part model element removal and post-machining stress-strain gradient transfer mapping are then repeated in a real-time cycle such that the stresses and strains of the post-machining stress-strain gradient of the macro part model elements are allowed to resolve or relax in a time-realistic manner. In this way, part machining is simulated on a macro level with time-realistic, micro level realistic physics. It should be noted that element removal, post-machining stress-strain gradient transfer mapping, and/or other steps may occur simultaneously.

The above-described method provides many advantages. For example, performing the macro level machining simulation in a real-time cycle provides more accurate macro-level stress-strain results. The present invention captures the effects of machining stresses on subsequent machining passes, thus accounting for the effect of toolpaths. Material conditions prior to machining, such as residual stresses due to forging, are taken into account when mapping surface stresses. The above-described method may also be used to simulate welding, soldering, and other operations, where temperature or another variable is the mapping criterion and where tool proximity triggers heat flux instead of element removal.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the present invention will be apparent from the detailed description of the embodiments and the accompanying drawing figures.

### DRAWINGS

Embodiments of the present invention are described in detail below with reference to the attached drawing figures, wherein:

FIG. 1 is a block diagram of an exemplary computer system that may be used to implement embodiments of the invention;

FIG. 2 is a flowchart of a method of simulating machining effects in accordance with an embodiment of the invention;

FIG. 3 is a perspective view of a micro reference model;

FIG. 4 is a perspective view of a set of micro level finite elements of the micro reference model of FIG. 3 having a pre-machining stress-strain gradient;

FIG. 5 is a perspective view of the set of micro level finite elements of FIG. 4 having a post-machining stress-strain gradient;

FIG. 6 is a perspective view of a macro level part model during a machining simulation; and

FIG. 7 is a flowchart of another method of simulating machining effects in accordance with another embodiment of the invention.

### DETAILED DESCRIPTION

The following detailed description of embodiments of the invention references the accompanying figures. The embodiments are intended to describe aspects of the invention in sufficient detail to enable those with ordinary skill in the art to practice the invention. Other embodiments may be utilized and changes may be made without departing from the scope of the claims. The following description is, therefore, not limiting. The scope of the present invention is defined only by the appended claims, along with the full scope of equivalents to which such claims are entitled.

In this description, references to “one embodiment”, “an embodiment”, or “embodiments” mean that the feature or features referred to are included in at least one embodiment of the invention. Separate references to “one embodiment”, “an embodiment”, or “embodiments” in this description do not necessarily refer to the same embodiment and are not mutually exclusive unless so stated. Specifically, a feature, structure, act, etc. described in one embodiment may also be included in other embodiments, but is not necessarily included. Thus, particular configurations of the present invention can include a variety of combinations and/or integrations of the embodiments described herein.

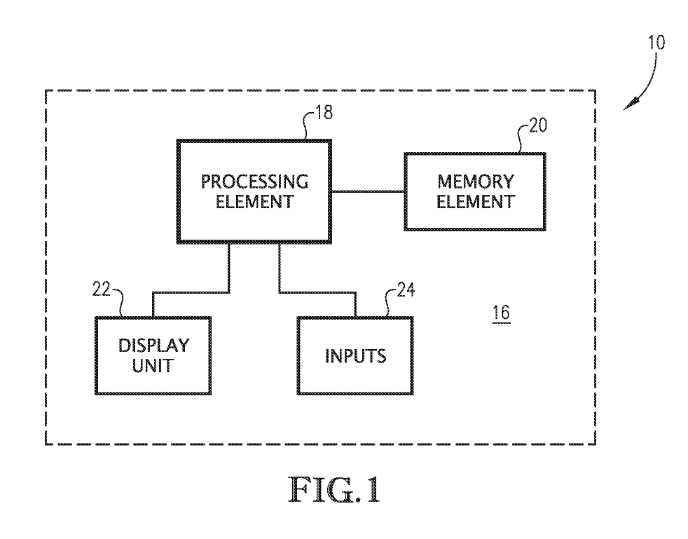

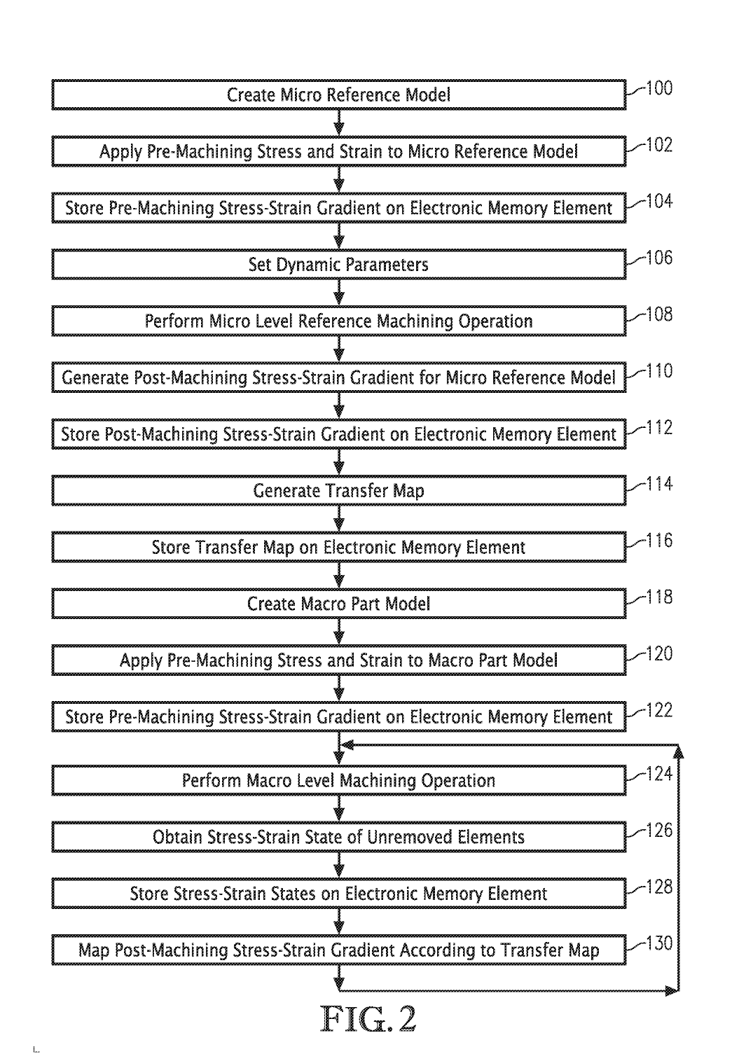

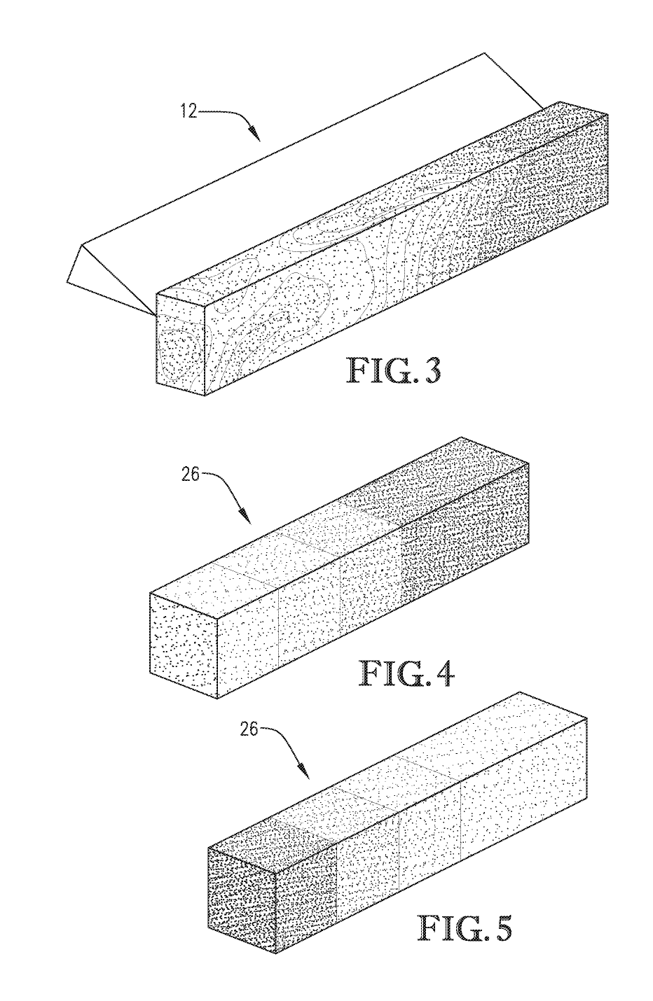

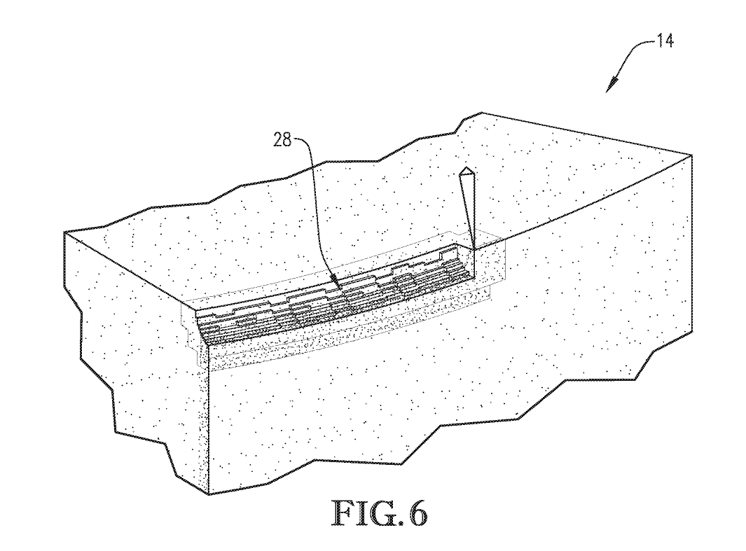

Turning to the drawing figures, and in particular FIGS. 1 and 2, an exemplary computing system 10 is illustrated that may be used to implement embodiments of the invention. The computing system 10 may be used for creating a micro reference model 12 (FIGS. 3-5) and a macro part model 14 (FIG. 6) and for improving the simulation of machining effects on the macro part model 14 via the micro reference model 12. The computing system 10 broadly comprises one or more computing devices 16 including an electronic processing element 18, an electronic memory element 20, a display unit 22, and a plurality of inputs 24.

The electronic processing element 18 generates the macro part model 14, micro reference model 12, and other computer data supporting the simulation described herein according to inputs and data received from a user. The electronic processing element 18 may include a circuit board, memory, display, inputs, and/or other electronic components such as a transceiver or external connection for communicating with external computers and the like.

The electronic processing element 18 may implement aspects of the present invention with one or more computer programs stored in or on computer-readable medium residing on or accessible by the processor. Each computer program preferably comprises an ordered listing of executable instructions for implementing logical functions in the electronic processing element 18. Each computer program can be embodied in any non-transitory computer-readable medium, such as the electronic memory element 20 (described below), for use by or in connection with an instruction execution system, apparatus, or device, such as a computer-based system, processor-containing system, or other system that can fetch the instructions from the instruction execution system, apparatus, or device, and execute the instructions.

The memory element 20 may be any computer-readable non-transitory medium that can store the program for use by or in connection with the instruction execution system, apparatus, or device. The computer-readable medium can be, for example, but not limited to, an electronic, magnetic, optical, electro-magnetic, infrared, or semi-conductor system, apparatus, or device. More specific, although not inclusive, examples of the computer-readable medium would include the following: an electrical connection having one or more wires, a portable computer diskette, a random access memory (RAM), a read-only memory (ROM), an erasable, programmable, read-only memory (EPROM or Flash memory), an optical fiber, and a portable compact disk read-only memory (CDROM).

The display unit 22 displays graphical representations of the macro part model 14, micro reference model 12, and simulations described herein. The display unit 22 may be any suitable computer screen or other visual output unit.

The inputs 24 allow a user to manipulate the macro part model 14 and micro reference model 12, input data, and select or change parameters, variables, and other settings. The inputs may be a computer keyboard, mouse, touchscreen, or any other suitable input device.

Turning to FIGS. 2-6, simulating machining effects according to an embodiment of the invention will now be described in more detail. The computing device 16 may perform the following computer-implemented method without substantial human interaction (beyond the interactions of, e.g., initiating a step, providing a value used by a step, etc.).

First, the micro reference model 12 may be created, as shown in block 100 of FIG. 2. The micro reference model 12 may comprise a plurality of micro reference model elements 26.

Pre-machining stress and strain may then be induced on the micro reference model 12 such that the micro reference model elements 26 have a pre-machining stress-strain gradient, as shown in block 102. For example, forging, extrusion, or casting stresses and strains may be induced on the micro reference model 12. The pre-machining stress-strain gradient may then be stored on the electronic memory element 20, as shown in block 104.

Dynamic parameters of the micro reference model 12 may then be selected according to one of a plurality of machining operations, as shown in block 106. This affords wide versatility to the present invention for simulating various machining operations in various conditions. A user may choose a machining operation via inputs 24 and the dynamic parameters may automatically be selected according to the user's input. Alternatively, the user may directly select the dynamic parameters.

The selected reference machining operation may then be performed on the micro reference model 12 such that machining stress and strain are imparted on the micro reference model 12, as shown in block 108. Micro reference model elements 26 surviving the reference machining operation will thus have a post-machining stress-strain gradient, as shown in block 110. The reference machining operation may comprise standard machining simulation modeling including the use of a reference machining tool and realistic physics to the level of complexity desired. For example, the reference machining operation may simulate the tool ploughing through material to obtain stresses, strains, reaction forces, and other data. Outputs of the micro level reference machining operation will be the basis for element death criteria (element removal) on the macro model level and may also be the basis for cohesive failure modeling on the macro model level. The post-machining stress-strain gradient may then be stored on the electronic memory element 20, as shown in block 112.

A transfer map based on the pre-machining stress-strain gradient and the post-machining stress-strain gradient may then be created, as shown in block 114. In its simplest form, the transfer map forms one-to-one relationships between data points of the pre-machining stress-strain gradient and data points of the post-machining stress-strain gradient. In more complex forms, relationships between data points of the pre-machining stress-strain gradient and data points of the post-machining stress-strain gradient may be conditional or modified based on predetermined criteria. The transfer map may then be stored on the electronic memory element 20, as shown in block 116.

The macro part model 14 may then be created, as shown in block 118. The macro part model 14 may comprise a plurality of macro part model elements 28.

Pre-machining stress and strain may then be induced on the macro part model 14 such that the macro part model elements 28 have a pre-machining stress-strain gradient, as shown in block 120. For example, extrusion or casting stresses may be induced on the macro part model 14. The pre-machining stress-strain gradient of the macro part model 14 may then be stored on the electronic memory element 20, as shown in block 122.

A machining operation may then be performed on the macro part model 14, as shown in block 124. More specifically, one or more macro part model elements 28 may be selected for removal from the macro part model 14 to simulate physical removal of material. This will result in a number of unremoved macro part model elements 28 remaining. Macro part model elements 28 being removed may be selected based on coordinate space locations of the macro part model elements 28, element connectivity of the macro part model elements 28, or any other suitable paradigm. In most embodiments, macro part model elements 28 or groups of macro part model elements 28 may be removed in succession along a tool path so as to simulate physical removal of material via a machining tool. In some embodiments, the macro level machining operation uses a point load force following a tool path on the macro part model geometry.

At this point, the unremoved macro part model elements 28 have a stress-strain state, as shown in block 126, that may or may not be slightly affected by the nearby element removal. The stress-strain state may be stored on the electronic memory element 20, as shown in block 128. The stress-strain state will be used as a basis for micro reference model transfer mapping as described below.

The post-machining stress-strain gradient of the micro reference model 12 may then be mapped to the unremoved macro part model elements 28 according to the transfer map such that the unremoved macro part model elements 28 have a post-machining stress-strain gradient based on the pre-machining stress-strain gradient and the post-machining stress-strain gradient of the micro reference model 12 and the stress-strain state of the unremoved macro part model elements 28, as shown in block 130.

In some embodiments, each macro part model element 28 is mapped to match values of specific micro reference model elements 26 whose “before” value is the closest. That is, post machining stress-strain values of the post-machining stress-strain gradient are mapped to unremoved macro part model elements according to increasing differences between pre-machining stress-strain values of the micro reference model elements 26 and pre-machining stress-strain values of the macro part model elements 28. This may be called a nearest neighbor approach.

In other embodiments, a piecewise linear function may be generated according to all of the micro reference model elements 26. This allows values form the micro reference model elements 26 to be interpolated to more closely match the “before” values on the macro part model element 28, even if there is not actually a micro reference model element 26 near that value. That is, post-machining stress-strain values of the post-machining stress-strain gradient are mapped to unremoved macro part model elements 28 according to increasing differences between output data points of the function and pre-machining stress-strain values of the macro part model elements 28. Quadratic functions and other higher-order functions may also be used for mapping interpolation.

The mapping may be based on “before” and “after” values of equivalent plastic strain (EQPS), Cauchy stress, or any other suitable material property. For more complex material models such as the Bammann-Chiesa-Johnson Microstructural Evolution Model (BCJ-MEM) model, recrystallization, estimated room temperature yield stress, and other material properties may be used. Many material models have hundreds of variables, any of which could potentially be used in this regard. Multiple variables could even be used in conjunction with each other.

Blocks 124-130 are then repeated in a real-time cycle such that the stresses and strains of the post-machining stress-strain gradient of the macro part model elements 28 are allowed to resolve or relax in a time-realistic manner. This effectively simulates machining of a part on a macro level with time-realistic micro level realistic physics. It should be noted that element removal, post-machining stress-strain gradient transfer mapping, and/or other steps may occur simultaneously.

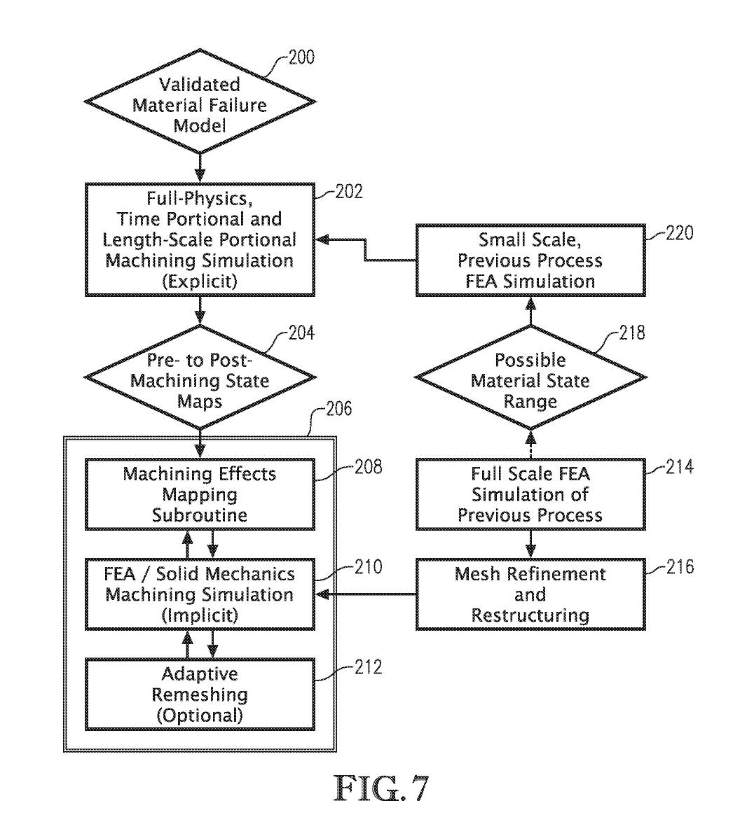

An exemplary simulation will now be described, with reference to FIG. 7. First, a validated material failure model is created, as shown in block 200. A full-physics, time portional and length-scale portional machining simulation is performed on the failure model, as shown in block 202. That is, the machining simulation may temporally span only a fraction of a machining event (e.g., on the order of microseconds of a minutes-long machining event, with a time resolution on the nanosecond scale). The machining simulation also may cover only a portion of the failure model. Pre-machining to post-machining state maps may then be generated from the machining simulation, as shown in block 204. Full time and full length-scale machining in the virtual space is then performed, as shown in block 206. That is, the machining in the virtual space may temporally span the entire machining event (e.g., on the order of minutes, with a time resolution on the seconds scale). This may include a machining effects mapping subroutine (block 208), finite element analysis (block 210), and optional adaptive re-meshing (block 212).

Some of the above simulations may utilize pre-performed simulations of previous processes. For example, the finite element analysis (block 210) may utilize a full scale finite element analysis simulation of a previous process (block 214) subjected to mesh refinement and restructuring (block 216). The full scale finite element analysis simulation of a previous process (block 214) may also be used to inform a possible material state range (block 218) of a small scale previous process finite element analysis simulation (block 220). This in turn can be utilized in the full-physics, time portional and length-scale portional machining simulation of block 202.

The above-described computing system 10 and method provide many advantages over conventional systems. For example, performing the macro level machining steps in a real-time cycle provides more accurate stress-strain results for the entirety of the macro level machining simulation. The present invention captures the effects of machining stresses on subsequent machining passes, thus accounting for the impact of toolpaths. Material conditions prior to machining, such as residual stresses due to forging, are taken into account when mapping surface stresses. The above-described method may also be used to simulate welding, soldering, and other operations, where temperature or another variable is the mapping criterion, and tool proximity triggers heat flux instead of element removal.

Although the invention has been described with reference to the one or more embodiments illustrated in the figures, it is understood that equivalents may be employed and substitutions made herein without departing from the scope of the invention as recited in the claims.

Having thus described one or more embodiments of the invention, what is claimed as new and desired to be protected by Letters Patent includes the following:

1. A computer-implemented method for simulating machining effects in an object, the computer-implemented method comprising the steps of:
a) receiving data representative of a micro reference model comprising a plurality of micro reference model elements having a pre-machining stress-strain gradient;
b) receiving data representative of the plurality of micro reference model elements having a post-machining stress-strain gradient;
c) receiving a transfer map based on the pre-machining stress-strain gradient and the post-machining stress-strain gradient;
d) receiving data representative of a macro part model comprising a plurality of macro part model elements having a pre-machining stress-strain gradient;
e) removing a macro part model element from the macro part model so as to simulate physical removal of material such that a number of unremoved macro part model elements remain, the unremoved macro part model elements having a stress-strain state;
f) mapping the post-machining stress-strain gradient to the unremoved macro part model elements according to the transfer map such that the unremoved macro part model elements have a post-machining stress-strain gradient based on the pre-machining stress-strain gradient and the post-machining stress-strain gradient of the micro reference model and the stress-strain state of the unremoved macro part model elements; and
g) repeating steps e)-f) in a real time cycle such that the stresses and strains in the unremoved macro part model elements resolve in a time-realistic manner.

2. The method of claim 1, wherein the macro part model element being removed is selected for removal based on coordinate space locations of the elements.

3. The method of claim 1, wherein the macro part model element being removed is selected for removal based on element connectivity of the macro part model elements.

4. The method of claim 1, further comprising the step of simulating a machining operation on the micro reference model.

5. The method of claim 4, wherein the machining operation simulation is a full-physics simulation.

6. The method of claim 4, wherein the machining operation is a time portional simulation.

7. The method of claim 4, wherein the machining operation is a full length-scale simulation.

8. The method of claim 1, wherein macro part model elements or groups of macro part model elements are removed in succession along a tool path so as to simulate physical removal of material via a machining tool.

9. The method of claim 8, further comprising the step of selecting dynamic parameters of the micro reference model according to one of a plurality of machining operations.

10. The method of claim 1, wherein the mapping step includes mapping post-machining stress-strain values of the post-machining stress-strain gradient to unremoved macro part model elements according to increasing differences between pre-machining stress-strain values of the micro part model elements and pre-machining stress-strain values of the macro part model elements.

11. The method of claim 1, further comprising the step of generating a function based on pre-machining stress-strain values of the pre-machining stress-strain gradient, wherein the mapping step includes mapping post-machining stress-strain values of the post-machining stress-strain gradient to unremoved macro part model elements according to increasing differences between output data points of the function and pre-machining stress-strain values of the macro part model elements.

12. The method of claim 11, wherein the function is a linear function.

13. The method of claim 11, wherein the function is a quadratic function or higher order function.

14. The method of claim 1, wherein the transfer map is based on equivalent plastic strain (EQPS).

15. The method of claim 1, wherein the transfer map is based on Cauchy stress.

16. A computer-implemented method for simulating machining effects in an object, the computer implemented method comprising the steps of:
a) generating data representative of a micro reference model comprising a plurality of micro reference model elements;
b) generating data representative of the micro reference model elements having a pre-machining stress-strain gradient;
c) simulating a machining operation on the micro reference model;
d) generating data representative of the micro reference model elements having a post-machining stress-strain gradient;
e) generating a transfer map based on the pre-machining stress-strain gradient and the post-machining stress-strain gradient;
f) generating data representative of a macro part model comprising a plurality of elements;
g) generating data representative of the macro part model elements having a pre-machining stress-strain gradient;
h) removing a macro part model element from the macro part model so as to simulate physical removal of material such that a number of unremoved macro part model elements remain, the unremoved macro part model elements having a stress-strain state;
i) mapping the post-machining stress-strain gradient to the unremoved macro part model elements according to the transfer map such that the unremoved macro part model elements have a post-machining stress-strain gradient based on the pre-machining stress-strain gradient and the post-machining stress-strain gradient of the micro reference model and the stress-strain state of the unremoved macro part model elements; and
j) repeating steps h)-i) in a real time cycle such that the stresses and strains in the unremoved macro part model elements resolve in a time-realistic manner.

17. The method of claim 16, wherein the macro part model element being removed is selected for removal based on coordinate space locations of the elements.

18. The method of claim 16, wherein the macro part model element being removed is selected for removal based on element connectivity of the macro part model elements.

19. The method of claim 16, wherein macro part model elements or groups of macro part model elements are removed in succession along a tool path so as to simulate physical removal of material via a machining tool.

20. A computer-implemented method for simulating machining effects in an object, the computer implemented method comprising the steps of:
a) generating data representative of a micro reference model comprising a plurality of micro reference model elements;
b) generating data representative of the micro reference model elements having a pre-machining stress-strain gradient;
c) simulating a machining operation on the micro reference model;
d) generating data representative of the micro reference model elements having a post-machining stress-strain gradient;
e) generating a transfer map based on the pre-machining stress-strain gradient and the post-machining stress-strain gradient;
f) generating data representative of a macro part model comprising a plurality of elements;
g) generating data representative of the macro part model elements having a pre-machining stress-strain gradient;
h) selecting a macro part model element for removal based on element connectivity of the macro part model elements;
i) removing the selected macro part model element from the macro part model so as to simulate physical removal of material such that a number of unremoved macro part model elements remain, the unremoved macro pat model elements having a stress-strain state;
j) mapping the post-machining stress-strain gradient to the unremoved macro part model elements according to the transfer map such that the unremoved macro part model elements have a post-machining stress-strain gradient based on the pre-machining stress-strain gradient and the post-machining stress-strain gradient of the micro reference model and the stress-strain state of the unremoved macro part model elements; and
k) repeating steps i)-j) in a real time cycle such that the stresses and strains in the unremoved macro part model elements resolve in a time-realistic manner, wherein macro part model elements or groups of macro part model elements are removed in succession along a tool path so as to simulate physical removal of material via a machining tool.
